(19) United States
(12) Patent Application Publication
(10) Pub. No.: US 2022/0361448 A1
(43) Pub. Date: Nov. 17, 2022

(54) PET DETERRENT AND AREA PROTECTION SYSTEM

(71) Applicants: Kenneth LaBruyere, Washington, MI (US); Daniel LaBruyere, Clinton Township, MI (US)

(72) Inventors: Kenneth LaBruyere, Washington, MI (US); Daniel LaBruyere, Clinton Township, MI (US)

(21) Appl. No.: 17/316,814

(22) Filed: May 11, 2021

(51) Int. Cl. A01K 15/02; A01K 11/00

(52) U.S. Cl. CPC A01K 15/023; A01K 11/006

(57) ABSTRACT

A system that uses Active Reader Passive Tag Radio Frequency Identification for deterring pets and protecting specific areas of a household.

### BACKGROUND OF THE INVENTION

This application deals with a system that uses Active Reader Passive Tag Radio Frequency Identification for deterring pets and protecting specific areas of a household.

Several types of systems can be found in the art, namely U.S. Pat. No. 6,668,760 that issued on Dec. 30, 2003 to Groh, et al. in which there is disclosed an apparatus for controlling the barking of a dog through application of a spray deterrent. The spray control bark collar detects the barking of the dog through measuring vibrations produced by the dog barking.

U.S. Pat. No. 7,658,166, that issued Feb. 9, 2010 to Rheinschmidt et. Al. deals with a system to train a dog to reduce barking. There is a bark switch connected between a transformer and a power supply, a water valve operatively connected to the transformer and connected between a supply hose and a spray hose.

U.S. Pat. No. 7,992,525, that issued Aug. 9, 2011 to Terri L. Fisher deals with a device for controlling an animal's behavior. The device is attached to the animal's body with the triggering mechanism against the animal's skin.

U.S. Pat. No. 8,091,512, that issued Jan. 10, 2012 to So deals with a spray deterrent application type of animal training apparatus that is worn by the animal.

U.S. Pat. No. 9,185,884, that issued Nov. 17, 2015 to Herrmann deals with a method for animal control that includes receiving a signal provided by a collar worn by the animal.

U.S. Pat. 9,943,067 that issued Apr. 17, 2018 to Mainini deals with a device that includes a sound or motion sensor that is configured to generate electrical signals in response to an occurrence.

U.S. Pat. No. 10,098,323 that issued Oct. 16, 2018 to Touchton, et al deals with an animal training system including a portable remote transceiver for a user for transmitting a remote animal control signal to a remote animal transceiver on an animal.

U.S. Pat. No. 10,514,439 that issued Dec. 24, 2019 to Seltzer deals with a wireless animal location system that identifies a location of a roaming pet.

None of the prior art noted Supra deals with the instant invention.

### THE INVENTION

Thus, what is taught and disclosed in this specification is a pet deterrent and area protection system. The system comprises in combination a radio frequency identification tag worn by a pet and at least one powered receiving tower for a radio frequency signal from the radio frequency identification tag. The tower is equipped with a deterrent system for the pet and a control system for the tower.

### BRIEF DESCRIPTION OF THE DRAWINGS

FIG. 1 is a full view of a device of this invention.

FIG. 2 is a cross-sectional view of FIG. 1.

FIG. 3A is an illustration of litter box in which the program is okay for a cat, but not a dog.

FIG. 3B is an illustration of an armchair in which the program is okay for a dog, but not for a cat.

### DETAILED DESCRIPTION OF THE DRAWINGS

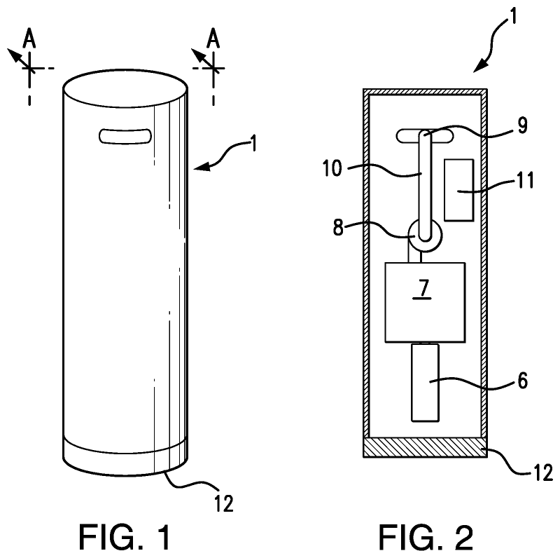

The pet deterrent and area protection system tower 1 of this invention is shown in FIG. 1. FIG. 2 is a cross-sectional view through line A-A of FIG. 1 showing the component tower 1 of this invention.

FIG. 2 is a full cross-sectional side view of the tower 1 showing the power source, which is a battery 6, a water reservoir 7, a water pump 8, a nozzle 9 with a conduit 10. Also shown is the radio frequency receiver 11, and a detachable base 12. The tower can be powered by hard wire as well.

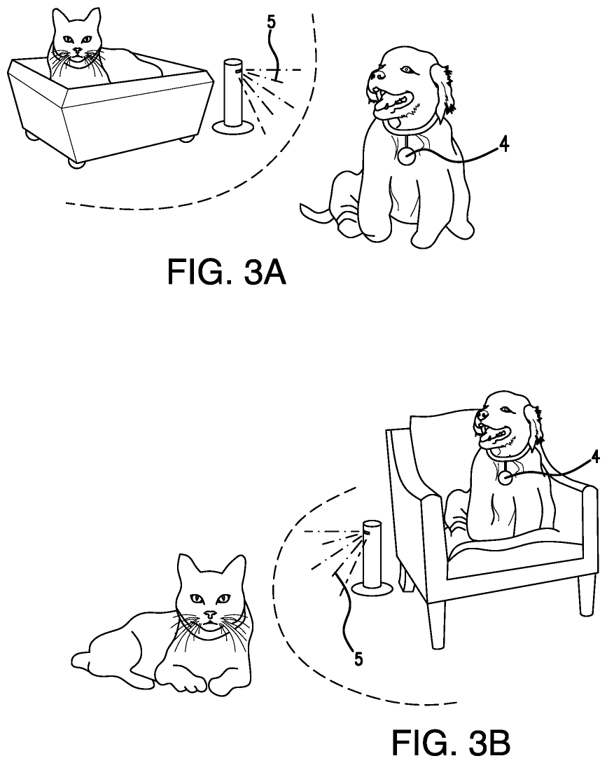

Animals are fitted with a unique identification tag 4 (FIGS. 3A and 3B) and towers 1 are setup in locations where there is a need or desire to limit some or all pet access. Each pet is either assigned access or no access past each tower 1. Owing to programming, if a pet has access at a certain tower or group of towers, then nothing happens. If the pet is not granted access, the tower near the pet will squirt the pet harmlessly with a small amount of water or water solution. If desired a scent can be added to the water so as to identify that the pet had wandered where it was forbidden.

The tower 1 uses Active Reader Passive Tag (ARPT) radio frequency identification technology to monitor the movements of pets and to trigger the delivery of a deterrent when pets enter areas of the home that the pet owner wishes to protect. In addition, this system can control the visitation of unwanted pets to such things as litter boxes, food dishes or trays and the like. Protection can be had for furniture and other like items by this system.

The tower 1 employs water spray 5 or water solution sprays as a deterrent among other items. These are sprayed from nozzles 9 mounted on the towers 1. The towers 1 utilize an active RFID reader 11 which transmits interrogating signals, seeking the unique IDs assigned to each pet. If a pet RFID tag 4 enters an excluded area, the tower 1 will spray a solution or water mist 5 via the nozzles 9.

Multiple towers 1 can be integrated to the system throughout a household, or in multiple households like vacation homes, pet sitters, and the like.

The RFID reader on the tower 11 can identify a pet tag 4 from a distance of up to 12 meters. The towers 1 include a water tank 7 that can be refilled by the pet owner as needed. Water is pumped from the tank 7 and delivered to the nozzles 9 via a conduit 10. Passive RFID tags are placed on the pet, usually a collar connection. Unique IDs can be assigned to each pet in the household allowing for varying permissions or exclusions. Permissions and exclusions are assigned by the pet owner via software using mobile apps, web site or similar items. For example, a house cat can be provided permission to assess a litter box, while the family dog is excluded from the area surrounding the litter box FIG. 3A. Likewise, a dog can be allowed access to a piece of furniture, but the cat is excluded from the are surrounding the furniture (FIG. 3B). Towers or pet tags are easily removed or replaced with this system.

What is claimed is:

1. A pet deterrent and area protection system, said system comprising in combination:
A) a radio frequency identification tag worn by a pet;
B) at least one powered receiving tower for a radio frequency signal from said radio frequency identification tag, said tower being equipped with a deterrent system for said pet and a control system for said tower.

2. A pet deterrent and area protection system as claimed in claim 1 wherein said power is a battery.

3. A pet deterrent and area protection system as claimed in claim 1 wherein said power is hard wired.

4. A pet deterrent and area protection system as claimed in claim 1 wherein the deterrent system is a water solution.

5. A pet deterrent and area protection system as claimed in claim 1 wherein the deterrent is water.

6. A pet deterrent and area protection system as claimed in claim 4 wherein the solution is water and a fragrance.

7. A pet deterrent and area protection system as claimed in claim 1 wherein the deterrent is a chemical.

8. A pet deterrent and area protection system as claimed in claim 4 wherein the deterrent is a solution of water and chemical.
